(19) United States
(12) Patent Application Publication
(10) Pub. No.: US 2015/0188217 A1
(43) Pub. Date: Jul. 2, 2015

(54) WEARABLE DEVICE WITH ANTENNA STRUCTURE

(71) Applicant: QUANTA COMPUTER INC., Kuei Shan Hsiang (TW)

(72) Inventors: Chin-Lung Tsai, Kuei Shan Hsiang (TW); Kuo-Cheng Chen, Kuei Shan Hsiang (TW); Men-Hsueh Tsai, Kuei Shan Hsiang (TW)

(73) Assignee: QUANTA COMPUTER INC., Kuei Shan Hsiang (TW)

(21) Appl. No.: 14/229,117

(22) Filed: Mar. 28, 2014

(30) Foreign Application Priority Data
Dec. 27, 2013 (TW) 102148607

(51) Int. Cl. H01Q 1/27; H01Q 7/00; G04R 60/06; H01Q 1/22

(52) U.S. Cl. CPC H01Q 1/273; H01Q 1/22; H01Q 7/00; G04R 60/06

(57) ABSTRACT

A wearable device includes a metal body, a nonconductive partition, and a metal loop. The metal body substantially has a hollow structure. The nonconductive partition is disposed on the metal body. The metal loop is disposed on the nonconductive partition. The metal loop has a feeding point and forms an antenna structure of the wearable device.

### CROSS REFERENCE TO RELATED APPLICATIONS

This Application claims priority of Taiwan Patent Application No. 102148607 filed on Dec. 27, 2013, the entirety of which is incorporated by reference herein.

### BACKGROUND OF THE INVENTION

1. Field of the Invention

The disclosure generally relates to a wearable device, and more particularly, to a wearable device and an antenna structure therein.

2. Description of the Related Art

With the progress of mobile communication technology, portable electronic devices, for example, portable computers, mobile phones, tablet computer, multimedia players, and other hybrid functional mobile devices, have become more common To satisfy the demand of users, portable electronic devices usually can perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi, Bluetooth, and WiMAX (Worldwide Interoperability for Microwave Access) systems and using frequency bands of 2.4 GHz, 3.5 GHz, 5.2 GHz, and 5.8 GHz.

According to some research reports, researchers predict the next generation of mobile devices will be “wearable devices”. For example, wireless communication may be applied to watches, glasses, and even clothes in the future. However, watches, for example, do not have a large enough space to accommodate antennas for wireless communication. Accordingly, this is a critical challenge for antenna designers.

### BRIEF SUMMARY OF THE INVENTION

To overcome the drawbacks of the prior art, in one exemplary embodiment, the disclosure is directed to a wearable device which includes a metal body, a nonconductive partition, and a metal loop. The metal body substantially has a hollow structure. The nonconductive partition is disposed on the metal body. The metal loop is disposed on the nonconductive partition. The metal loop has a feeding point and forms an antenna structure of the wearable device.

### BRIEF DESCRIPTION OF DRAWINGS

The invention can be more fully understood by reading the subsequent detailed description and examples with references made to the accompanying drawings, wherein:

FIG. 1A is a partial exploded view of a wearable device according to an embodiment of the invention;

FIG. 1B is a partial combined view of a wearable device according to an embodiment of the invention;

FIG. 1C is a complete combined view of a wearable device according to an embodiment of the invention;

FIG. 1D is a VSWR (Voltage Standing Wave Ratio) of an antenna structure of a wearable device according to an embodiment of the invention;

FIG. 2 is a partial exploded view of a wearable device according to an embodiment of the invention;

FIG. 3 is a partial exploded view of a wearable device according to an embodiment of the invention;

FIG. 4 is a partial exploded view of a wearable device according to an embodiment of the invention; and

FIG. 5 is a partial exploded view of a wearable device according to an embodiment of the invention.

### DETAILED DESCRIPTION OF THE INVENTION

In order to illustrate the purposes, features and advantages of the invention, the embodiments and figures of the invention are shown in detail as follows.

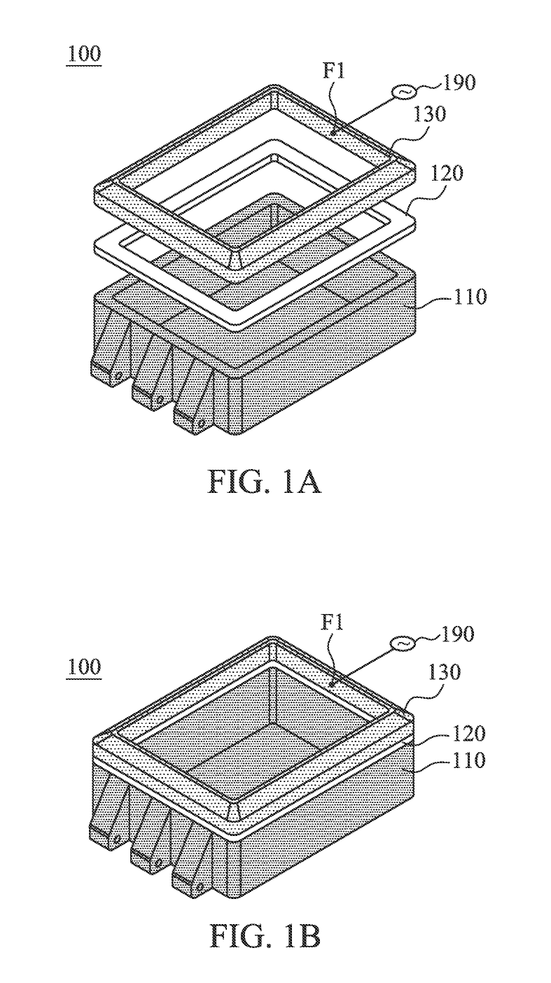

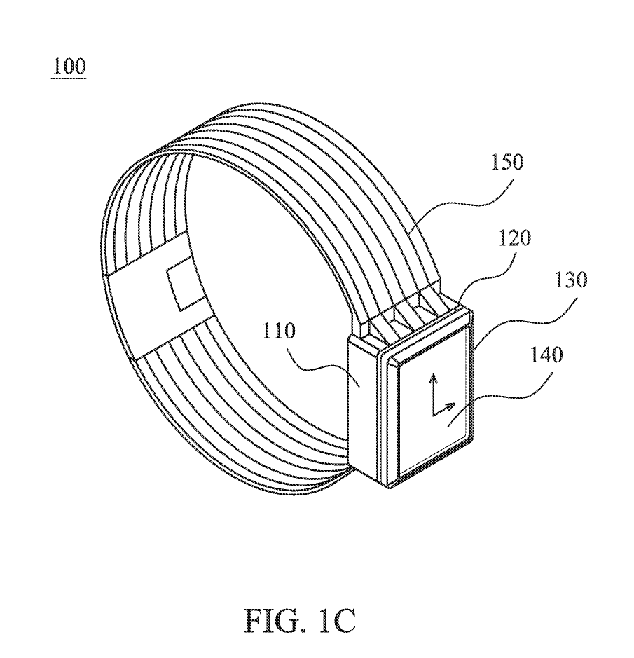

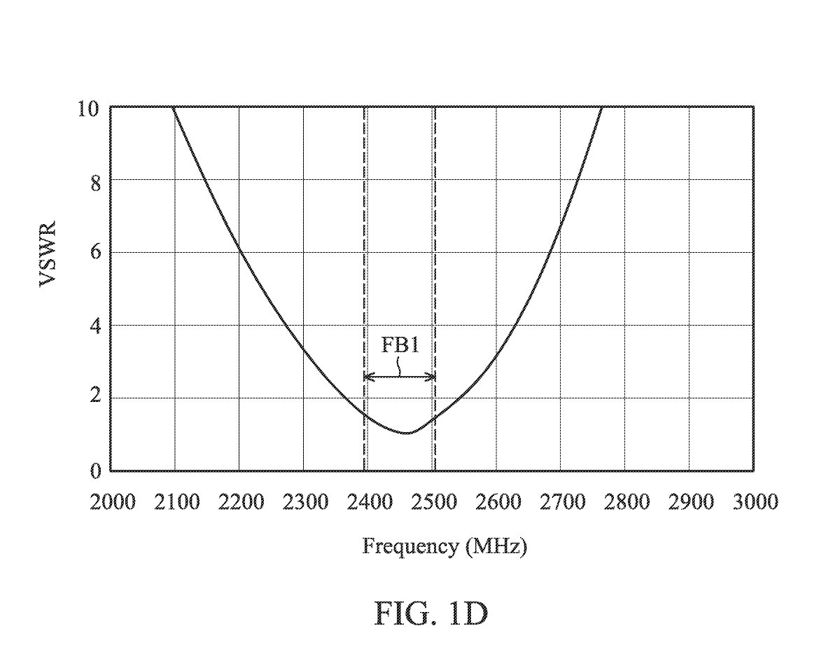

FIG. 1A is a partial exploded view of a wearable device 100 according to an embodiment of the invention. FIG. 1B is a partial combined view of the wearable device 100 according to an embodiment of the invention. Please refer to FIG. 1A and FIG. 1B together. In a preferred embodiment, the wearable device 100 is a wrist-wearable device, such as a smart watch or a smart, sporty bracelet. As shown in FIG. 1A and FIG. 1B, the wearable device 100 at least includes a metal body 110, a nonconductive partition 120, and a metal loop 130. The metal body 110 substantially has a hollow structure. The shape, pattern, and surface treatment of the metal body 110 are not limited in the invention. The nonconductive partition 120 may be made of plastic materials. The nonconductive partition 120 is disposed on the metal body 110, and is substantially positioned between the metal loop 130 and the metal body 110. The metal loop 130 is disposed on the nonconductive partition 120. The metal loop 130 forms an antenna structure of the wearable device 100. The metal loop 130 has a feeding point F1. The feeding point F1 may be coupled to a signal source 190, such as an RF (Radio Frequency) module for exciting the antenna structure. The position of the feeding point F1 is not limited in the invention. For example, the feeding point F1 may be positioned at the center of a side of the metal loop 130, or at a corner of the metal loop 130.

In some embodiments, the metal body 110 is substantially a box without a lid (e.g., a hollow cube without a lid to form a square opening), and the nonconductive partition 120 and the metal loop 130 are both disposed at an open side of the box. The metal body can accommodate a variety of device components, such as a battery, an hour hand, a minute hand, a second hand, an RF module, a signal processing module, a counter, a processor, a thermometer, and/or a barometer (not shown). In some embodiments, the nonconductive partition 120 substantially has a loop structure, and the size of the loop structure is substantially equivalent to the size of the metal loop 130. For example, the nonconductive partition 120 and the metal loop 130 may be two square loops with equal sizes, and they may fit a square opening of the metal body 110. Note that the wearable device 100 may further include other components, such as a time adjuster, a connection belt, and a buckle, although these components are not displayed in FIG. 1A and FIG. 1B.

FIG. 1C is a complete combined view of the wearable device 100 according to an embodiment of the invention. In the embodiment of FIG. 1C, the wearable device 100 is implemented with a watch. With such a design, the wearable device 100 further includes a transparent element 140 and a watchband 150. For example, the transparent element 140 may be a watch surface glass or a transparent plastic board. The transparent element 140 may be disposed inside the nonconductive partition 120, and may be surrounded by the nonconductive partition 120. Other watch components, such as an hour hand, a minute hand, and a second hand, may be all disposed under the transparent element 140 for a user to observe them. The watchband 150 may be connected to two opposite sides of the metal body 110, such that a user can wear the wearable device 100 on the wrist using the watchband 150.

FIG. 1D is a VSWR (Voltage Standing Wave Ratio) of the antenna structure of the wearable device 100 according to an embodiment of the invention. The horizontal axis represents the operation frequency (MHz), and the vertical axis represents the VSWR.

According to the measurement result of FIG. 1D, when the metal loop 130 of the wearable device 100 is fed from the signal source 190, the antenna structure is excited to generate at least one operation frequency band FB1. In some embodiments, the operation frequency band FB1 of the antenna structure is substantially from 2400 MHz to 2500 MHz. As a result, the wearable device 100 of the invention can support at least the wireless communication of Wi-Fi and Bluetooth frequency bands. Since the metal loop 130 is implemented with a light and thin metal piece and used as a portion of appearance of the wearable device 100, the present invention has the advantages of minimizing the antenna size, keeping the antenna bandwidth, reducing the manufacturing cost, and improving the device appearance, and it is suitable for applications in a variety of small-size smart wearable devices.

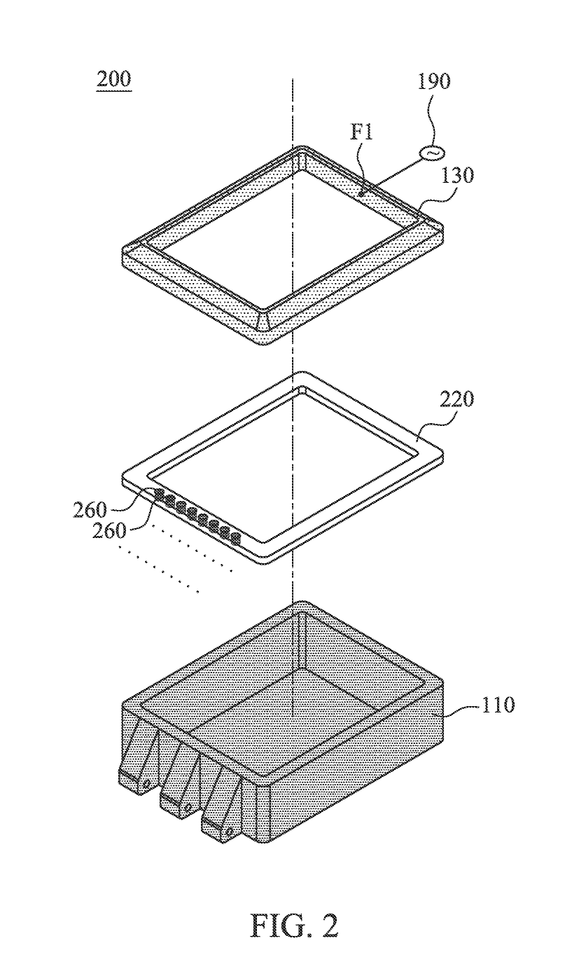

FIG. 2 is a partial exploded view of a wearable device 200 according to an embodiment of the invention. FIG. 2 is basically similar to FIG. 1A, FIG. 1B, and FIG. 1C. In the embodiment of FIG. 2, the wearable device 200 further includes one or more metal vias 260. The metal vias 260 may be formed in a nonconductive partition 220, and the metal loop 130 may be coupled through the metal vias 260 to the metal body 110. For example, the feeding point F1 and the metal vias 260 may be adjacent to two opposite sides of the metal loop 130, respectively. It is understood that the invention is not limited to the above. By changing the number and the position of metal vias 260, an antenna designer can adjust the resonant length and the impedance matching of the antenna structure of the wearable device 200 so as to control the operation frequency band of the antenna structure. Other features of the wearable device 200 of FIG. 2 are similar to those of the wearable device 100 of FIG. 1A, FIG. 1B, and FIG. 1C. Therefore, these embodiments can achieve similar levels of performance.

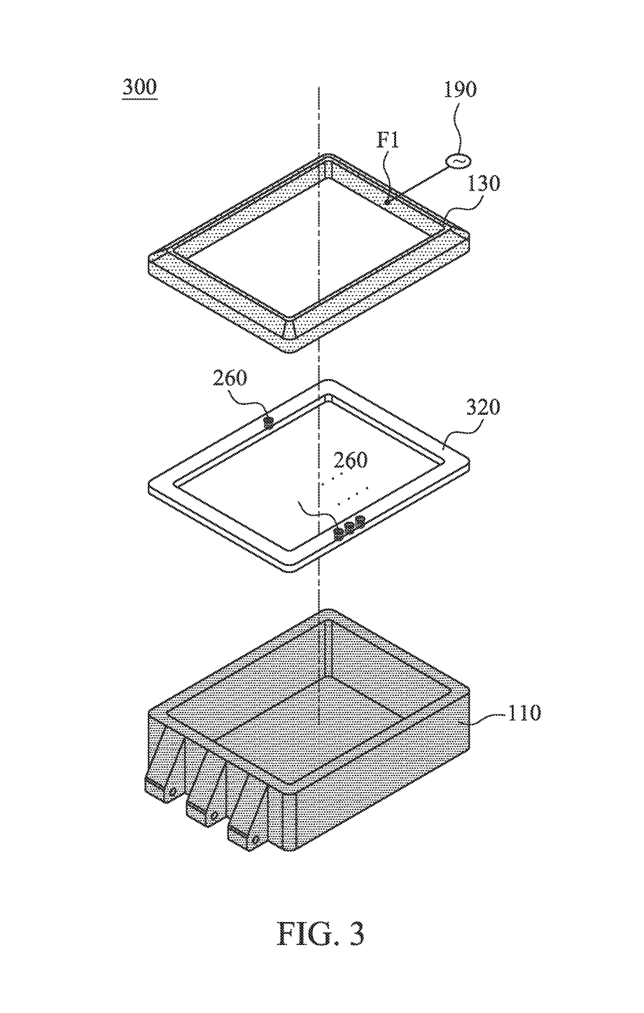

FIG. 3 is a partial exploded view of a wearable device 300 according to an embodiment of the invention. FIG. 3 is basically similar to FIG. 1A, FIG. 1B, and FIG. 1C. In the embodiment of FIG. 3, the wearable device 300 further includes one or more metal vias 260. The metal vias 260 may be formed in a nonconductive partition 320, and the metal loop 130 may be coupled through the metal vias 260 to the metal body 110. For example, the feeding point F1 and the metal vias 260 may be adjacent to three adjacent sides of the metal loop 130, respectively. More particularly, the metal vias 260 may be disposed in two opposite sides of the nonconductive partition 320 asymmetrically. It is understood that the invention is not limited to the above. By changing the number and the position of metal vias 260, an antenna designer can adjust the resonant length and the impedance matching of the antenna structure of the wearable device 300 so as to control the operation frequency band of the antenna structure. Other features of the wearable device 300 of FIG. 3 are similar to those of the wearable device 100 of FIG. 1A, FIG. 1B, and FIG. 1C. Therefore, these embodiments can achieve similar levels of performance.

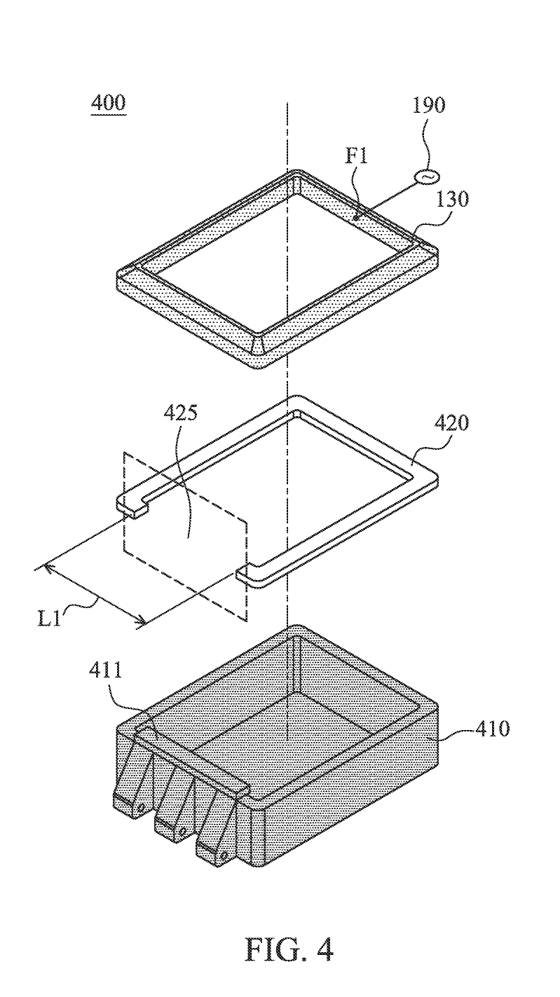

FIG. 4 is a partial exploded view of a wearable device 400 according to an embodiment of the invention. FIG. 4 is basically similar to FIG. 1A, FIG. 1B, and FIG. 1C. In the embodiment of FIG. 4, a nonconductive partition 420 of the wearable device 400 has a notch 425, and the metal loop 130 is coupled through the notch 425 of the nonconductive partition 420 to a metal body 410. More particularly, the metal body 410 may further include a protruded portion 411 which passes through the notch 425 of the nonconductive partition 420 so as to directly touch the metal loop 130. For example, the feeding point F1 and the notch 425 of the nonconductive partition 420 may be adjacent to two opposite sides of the metal loop 130, respectively. It is understood that the invention is not limited to the above. By changing the length L1 and the position of the notch 425 of the nonconductive partition 420, an antenna designer can adjust the resonant length and the impedance matching of the antenna structure of the wearable device 400 so as to control the operation frequency band of the antenna structure. Other features of the wearable device 400 of FIG. 4 are similar to those of the wearable device 100 of FIG. 1A, FIG. 1B, and FIG. 1C. Therefore, these embodiments can achieve similar levels of performance.

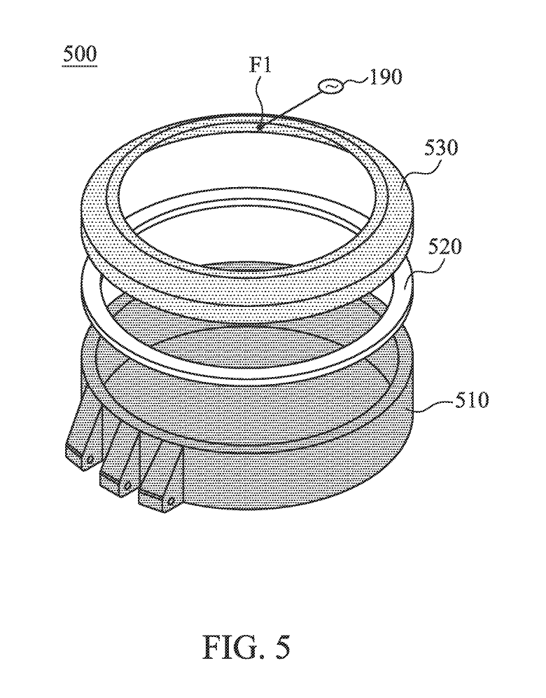

FIG. 5 is a partial exploded view of a wearable device 500 according to an embodiment of the invention. FIG. 5 is basically similar to FIG. 1A, FIG. 1B, and FIG. 1C. In the embodiment of FIG. 5, a metal body 510 of the wearable device 500 is substantially a hollow cylinder without a lid, and it has a circular opening. Furthermore, a nonconductive partition 520 and a metal loop 530 of the wearable device 500 may be two circular loops with equal sizes, and they may fit the circular opening of the metal body 510. In other embodiments, adjustments are made such that the metal body 510 is substantially a hollow elliptical cylinder without a lid, and the nonconductive partition 520 and the metal loop 530 are two elliptical loops with equal sizes. Other features of the wearable device 500 of FIG. 5 are similar to those of the wearable device 100 of FIG. 1A, FIG. 1B, and FIG. 1C. Therefore, these embodiments can achieve similar levels of performance.

Note that the above element sizes, element shapes, and frequency ranges are not limitations of the invention. An antenna designer can adjust these settings or values according to different requirements. It is understood that the wearable device and the antenna structure of the invention are not limited to the configurations of FIGS. 1-5. The invention may merely include any one or more features of any one or more embodiments of FIGS. 1-5. In other words, not all of the features shown in the figures should be implemented in the wearable device and the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. A wearable device, comprising:
a metal body, substantially having a hollow structure;
a nonconductive partition, disposed on the metal body; and
a metal loop, disposed on the nonconductive partition, wherein the metal loop has a feeding point and forms an antenna structure of the wearable device.

2. The wearable device as claimed in claim 1, wherein the wearable device is implemented with a watch.

3. The wearable device as claimed in claim 1, wherein the metal body is substantially a box without a lid, and the nonconductive partition and the metal loop are disposed at an open side of the box.

4. The wearable device as claimed in claim 1, wherein the nonconductive partition substantially has a loop structure, and a size of the loop structure is substantially equivalent to a size of the metal loop.

5. The wearable device as claimed in claim 4, further comprising:
a transparent element, disposed inside the nonconductive partition, wherein the transparent element is surrounded by the nonconductive partition.

6. The wearable device as claimed in claim 1, further comprising:
one or more metal vias, formed in the nonconductive partition, wherein the metal loop is coupled through the metal vias to the metal body.

7. The wearable device as claimed in claim 6, wherein the feeding point and

8. The wearable device as claimed in claim 1, wherein the nonconductive partition has a notch, and the metal loop is coupled through the notch to the metal body.

9. The wearable device as claimed in claim 8, wherein the feeding point and the notch of the nonconductive partition are adjacent to two opposite sides of the metal loop, respectively.

10. The wearable device as claimed in claim 1, wherein the antenna structure is excited to generate an operation frequency band from about 2400 MHz to about 2500 MHz.
